(19) United States
(12) Patent Application Publication
(10) Pub. No.: US 2024/0121240 A1
(43) Pub. Date: Apr. 11, 2024

(54) SYSTEM AND METHOD FOR PROVIDING MULTI-CHANNEL AUTHENTICATION

(71) Applicant: The Toronto-Dominion Bank, Toronto (CA)

(72) Inventors: Jacquelyn LIDDY, West Lorne (CA); Robert Dean ALLEN, London (CA); Joel David HAMMOND, London (CA); Vamshidhar PONNAMANENI, Brampton (CA); Ryan James TEVLIN, London (CA); Sara Sabrina Albuen SANTOS, Toronto (CA); Richard JONES, Garnet Valley, PA (US); Bijoy NAICK, Mississauga (CA); Blerina HOXHA, Etobicoke (CA); Merad KESTAY, London (CA); Catharine Eugenie BOUCHARD, Pickering (CA); Aniruddha Prakash KUNDLEY, Brampton (CA); Meredith Katharine Carter GREENFIELD, Toronto (CA)

(21) Appl. No.: 17/960,189

(22) Filed: Oct. 5, 2022

(51) Int. Cl. H04L 9/40

(52) U.S. Cl. CPC H04L 63/0884; H04L 63/102

(57) ABSTRACT

Computing platforms, methods, and storage media for providing multi-channel authentication are disclosed. Exemplary implementations may: receive, from a plurality of system access channels, authentication data related to a plurality of data transfers and to a plurality of users; consolidate the authentication data from the plurality of access channels to generate a set of consolidated authentication data; and generate a user interface, based on the set of consolidated authentication data, to enable execution of a centrally-provided authentication function at a selected system access channel for a selected user initiating a data transfer. An authentication hub according to an implementation may provide a common authentication experience and improved authentication for the plurality of access channels, which may include a telephone contact center, an in-person or branch location, and online services such as web-based or app-based.

### FIELD

The present disclosure relates to authentication, including but not limited to computing platforms, methods, and storage media for providing multi-channel authentication.

### BACKGROUND

Users accessing a service via a service provider's website or a dedicated application (app) may be provided with one or more authentication options. However, there are often limited authentication options when accessing a service via a contact center, or even in-person such as at a branch location. When authentication options are available via a contact center or in-branch, they typically rely on legacy processes.

Authentication options available via different channels (website, app, call center, branch) are decentralized, not scalable, and comprised of point solutions that may be duplicative, isolated, and expensive to run/maintain.

Current authentication at a contact center and in-person are insufficient and cannot be cross-utilized amongst other channels.

Improvements in approaches for providing multi-channel authentication are desirable.

### BRIEF DESCRIPTION OF THE DRAWINGS

Embodiments of the present disclosure will now be described, by way of example only, with reference to the attached Figures.

FIG. 1 illustrates a system configured for providing multi-channel authentication, in accordance with one or more embodiments.

FIG. 2 illustrates another system configured for providing multi-channel authentication, in accordance with one or more embodiments.

FIG. 3 illustrates a method for providing multi-channel authentication, in accordance with one or more embodiments.

FIGS. 4A, 4B and 4C are block and flow diagrams illustrating a system and method for authentication, including an authentication hub, in accordance with one or more embodiments.

FIG. 5 is a block and flow diagram illustrating a system and method for authentication, including an authentication hub, in accordance with one or more embodiments.

FIGS. 6A, 6B and 6C are block diagrams illustrating a system and method for authentication, including an authentication hub, in accordance with one or more embodiments, and illustrating interaction with authentication policies and orchestration components.

### DETAILED DESCRIPTION

Computing platforms, methods, and storage media for providing multi-channel authentication are disclosed. Exemplary implementations may: receive, from a plurality of system access channels, authentication data related to a plurality of data transfers and to a plurality of users; consolidate the authentication data from the plurality of access channels to generate a set of consolidated authentication data; and generate a user interface, based on the set of consolidated authentication data, to enable execution of a centrally-provided authentication function at a selected system access channel for a selected user initiating a data transfer.

The present disclosure provides consistent or improved authentication via an authentication hub to each of contact center, branches, and online services such as web-based or app-based services.

In an embodiment, the authentication hub is a “one stop shop” providing a common authentication experience for all access channels. Embodiments of the present disclosure enable users to view customer authentication histories and other details from any of the access channels. The authentication hub can replace multiple agent desktop screens that customer-facing staff often use to navigate through to service customers. High assurance methods enabled by the authentication hub may reduce/remove reliance on security questions. Deployment of the authentication hub may increase security, allow channels to service more customers, and reduce spending on change management for authentication solutions.

One aspect of the present disclosure relates to a computing platform configured for providing multi-channel authentication. The computing platform may include a non-transient computer-readable storage medium having executable instructions embodied thereon. The computing platform may include one or more hardware processors configured to execute the instructions. The processor(s) may execute the instructions to receive, from a plurality of system access channels, authentication data related to a plurality of data transfers and to a plurality of users. Each of the system access channels may provide access to functionality of the system in a different manner. The processor(s) may execute the instructions to consolidate the authentication data from the plurality of access channels to generate a set of consolidated authentication data. The processor(s) may execute the instructions to generate a user interface, based on the set of consolidated authentication data, to enable execution of a centrally-provided authentication function at a selected system access channel for a selected user initiating a data transfer.

Another aspect of the present disclosure relates to a method for providing multi-channel authentication. The method may include receiving, from a plurality of system access channels, authentication data related to a plurality of data transfers and to a plurality of users. Each of the system access channels may provide access to functionality of the system in a different manner. The method may include consolidating the authentication data from the plurality of access channels to generate a set of consolidated authentication data. The method may include generating a user interface, based on the set of consolidated authentication data, to enable execution of a centrally-provided authentication function at a selected system access channel for a selected user initiating a data transfer.

Yet another aspect of the present disclosure relates to a non-transient computer-readable storage medium having instructions embodied thereon, the instructions being executable by one or more processors to perform a method for providing multi-channel authentication. The method may include receiving, from a plurality of system access channels, authentication data related to a plurality of data transfers and to a plurality of users. Each of the system access channels may provide access to functionality of the system in a different manner. The method may include consolidating the authentication data from the plurality of access channels to generate a set of consolidated authentication data. The method may include generating a user interface, based on the set of consolidated authentication data, to enable execution of a centrally-provided authentication function at a selected system access channel for a selected user initiating a data transfer.

For the purpose of promoting an understanding of the principles of the disclosure, reference will now be made to the features illustrated in the drawings and specific language will be used to describe the same. It will nevertheless be understood that no limitation of the scope of the disclosure is thereby intended. Any alterations and further modifications, and any further applications of the principles of the disclosure as described herein are contemplated as would normally occur to one skilled in the art to which the disclosure relates. It will be apparent to those skilled in the relevant art that some features that are not relevant to the present disclosure may not be shown in the drawings for the sake of clarity.

Certain terms used in this application and their meaning as used in this context are set forth in the description below. To the extent a term used herein is not defined, it should be given the broadest definition persons in the pertinent art have given that term as reflected in at least one printed publication or issued patent. Further, the present processes are not limited by the usage of the terms shown below, as all equivalents, synonyms, new developments and terms or processes that serve the same or a similar purpose are considered to be within the scope of the present disclosure.

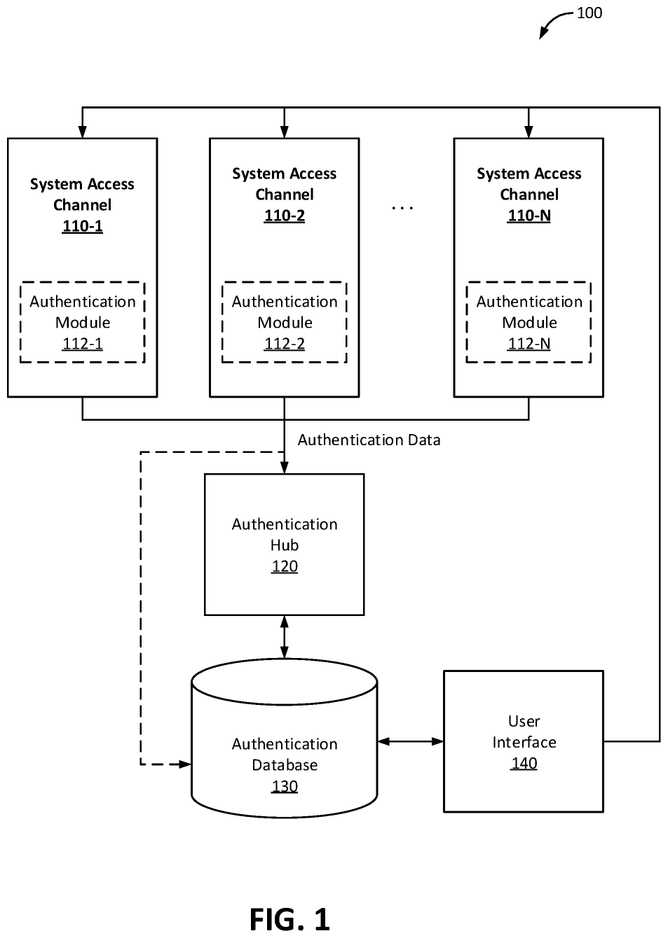

FIG. 1 illustrates a system 100 configured for providing multi-channel authentication, in accordance with one or more embodiments. The system 100 comprises a plurality of system access channels 110-1, 110-2 . . . 110-N configured to provide access to a back-end system (not shown). An authentication hub 120 is configured to receive, from one or more of the system access channels, authentication data related to one or more data transfers. The data transfers may comprise a request for data, a data response, a request for a file or status information, a file response or status information response, a transaction request or transaction response, a payment or fund transfer request or response, or other actions. Each of the system access channels provides access to functionality of the system in different manners, for example by telephone via a call center, by online services such as web access or via a dedicated app, or even in-person, at a brick-and-mortar location, such as a branch.

An authentication database 130 is configured to store and consolidate, from the one or more access channels, authentication data associated with a plurality of users to generate consolidated authentication data. The authentication database is in communication with the authentication hub 120, and may also be in communication with one or more of the system access channels. The authentication database 130 may receive the authentication data from the authentication hub 120 and/or from the plurality of system access channels. The system may generate a user interface 140 based on the consolidated authentication data in the authentication database 130. The user interface 140 may be configured to enable execution of a centrally-provided authentication function at a selected system access channel for a selected user initiating a data transfer. In an example implementation, the centrally-provided authentication function may comprise, for example, multi-factor authentication that is made available to any of the system access channels, even if a channel did not previously support or provide multi-factor authentication.

The authentication hub 120 may be configured to provide one or more high assurance authentication functions to the one or more access channels, where the high assurance functions are not otherwise available to the one or more access channels. For example, a telephone call center may not be equipped to provide multi-factor authentication, but the authentication hub 120 may be configured to provide multi-factor authentication to a telephone call center. The authentication hub 120 may advantageously provide, for each of a plurality of access channels, a similar level of authentication and risk profile.

In an implementation, the authentication hub 120 may be configured to receive, from a first system access channel, authentication data related to a selected data transfer from among the one or more data transfers and initiated by a selected user. The authentication hub 120, together with the authentication database 130, may be configured to store, from the first system access channel, first authentication data associated with the selected data transfer and the selected user. The system 100 may generate the user interface 140 based on the first authentication data, to enable execution of a centrally-provided authentication function at a second system access channel for the selected user.

Thus, in an embodiment, the authentication hub 120 and the authentication database 130 may cooperate to use authentication data from a first system access channel, for example authentication data from an app, to enable execution of a centrally-provided authentication function at a second system access channel, for example via a telephone call center. In so doing, the system 100 may provide, for a contact center access channel or an in-person access channel, a similar level of authentication and risk profile as a self-serve access channel.

The system 100 may include an authentication module provided at the one or more system access channels and configured for communication with the authentication hub 120 and/or with the authentication database 130. In the example shown in FIG. 1, the system 100 comprises a plurality of authentication modules 112-1, 112-2 . . . 112-N, one for each of the plurality of system access channels 110-1, 110-2 . . . 110-N. In an example implementation, each business line or system access channel may comprise an authentication module configured to communicate authentication activity, and to transmit the authentication activity to the authentication hub 120, which centralizes data from each module, or system access channel, or business line.

In the example embodiment of FIG. 1, the authentication module 112-1 may be configured to communicate authentication activity associated with the system access channel 110-1. The authentication module 112-1 may also be configured to communicate the authentication activity associated with the system access channel 110-1 to the authentication hub 120 and/or to the authentication database 130.

Embodiments of the present disclosure may create a standard enterprise solution, for example a single desktop tool that provides consistent authentication capabilities and experience to customer-facing staff in a contact center, branches and operations or back office. The authentication hub 120 provides a common experience to service customers in both contact center and branch, which will allow employees to view customer authentication histories, update profile preferences, access credentials and enrollment details. As an example, for contact center the authentication hub may replace the multiple agent desktop screens that the customer-facing staff may use to navigate through to service customers. The authentication hub 120 allows for system access channels to seamlessly integrate into the authentication ecosystem. The system access channels may utilize services and authenticators currently available and take advantage of new authenticators built in the future with a limited spend.

As a benefit to customers or users, customers calling in to the phone channel have not had available to them multi-factor authentication. Using the authentication hub 120 of embodiments of the present disclosure, multi-factor authentication may be enabled over a phone channel. As a benefit to solution providers, the authentication hub 120 assists in minimizing and reducing overall exposure of impersonation fraud. The authentication hub 120 facilitates an extra check. For example, for a phone transaction to move a big sum of money, the authentication hub 120 may be configured to perform extra due diligence to ensure the customer is who they say they are. The authentication hub 120 may provide one or more types of authenticators, including a ne-time passcode (OTP), and document verification services where a financial advisor remote/in-branch can verify customer's passport/license, and soft token authenticator. The authentication hub 120 may also make available other types of authenticators.

Embodiments of the present disclosure provide a centralized authentication hub 120 for all authentication methods. Embodiments of the present disclosure may add multi-factor authentication (MFA) to a phone channel. MFA has been available for self-service or online access, but now using embodiments of the present disclosure MFA can be made available to interactions via other service channels, such as via a call center or front line retail.

Existing legacy approaches are not as robust, and are less reliable from a risk perspective, and require more effort. When using a mobile app using a known approach, a user could select a “call me” function, and if the user is authenticated into the app, that authentication may transfer to a call center. However, the gap in such known approaches was that if the customer wasn't using the mobile app, they did not have access to any of those digital authenticators. Embodiments of the present disclosure put the infrastructure in place to allow someone in the branch or the call center to engage the user interface 140, identify or determine the available ways to authenticate the customer, and use one of those authentication methods enabled by the authentication hub 120 and the authentication database 130.

In an example implementation using the context of sending money, a strong authenticator, or multi factor authentication, is typically required. Embodiments of the present disclosure allow a customer to walk in to a physical service location or call by phone, and the service agents can use digital authenticators, enabled by the authentication hub 120. Embodiments of the present disclosure may be integrated into call centers, which are one of the system access channels, to run specific policies to confirm that authentication has happened, and that the authentication is sufficient for certain transactions. Embodiments of the present disclosure may automatically provide a prompt to increase authentication to satisfy requirements for new type of transaction. For example, based on a determination that the data transfer has a higher authentication threshold, for example a money transfer, the system may require, via the user interface 140, a corresponding increased level of authentication. In case of telephone call center flows, a workflow may not advance until a user has been authenticated in the authentication hub (AuthHub) 120, and optionally to an authentication level associated with the type of data transfer.

Embodiments of the present disclosure also make it simpler to onboard new customer-facing employees, from the perspective of authenticating customers. Such new employees, once they learn now to use the user interface 140 to engage the authentication hub 120, are empowered to use the same system to provide a reliable level of authentication for customers, regardless of the system access channel via which the customer may choose to connect.

In an example embodiment, the authentication hub 120 is aware of the authentication events that have happened on a current interaction, and recent interactions with the same customer. If a customer has had some recent failed authentication attempts, the authentication hub 120 will know, for example based on data stored in the authentication database 130. For example, the authentication hub 120 may be configured to collect and aggregate data to be able to detect that a mobile app is connected from a different country than where a user says they are right now, and to make other channels (e.g. phone, branch) aware of that determination.

Using known approaches, a phone agent does not currently know what a customer's authentication status is when the customer first calls in. When a customer calls in and says that they cannot login online, the phone agent can do a blind reset, but the phone agent does not know the customer's status directly. Currently, a phone agent may only have access to a text field on a mainframe system, and the phone agent must manually type in special codes if there is a fraud investigation on an account. Agents have to go in and decipher what the codes mean. All of this information is entered and reviewed manually, requiring one agent to enter data/observations, and the next agent to review and decipher the information, and act on the code that may be present. In known approaches, there is currently no control mechanism, and current system access channels are all siloed. Embodiments of the present disclosure address one or more of these drawbacks, by providing an authentication hub 120 providing a centralized authentication capability to a plurality of system access channels.

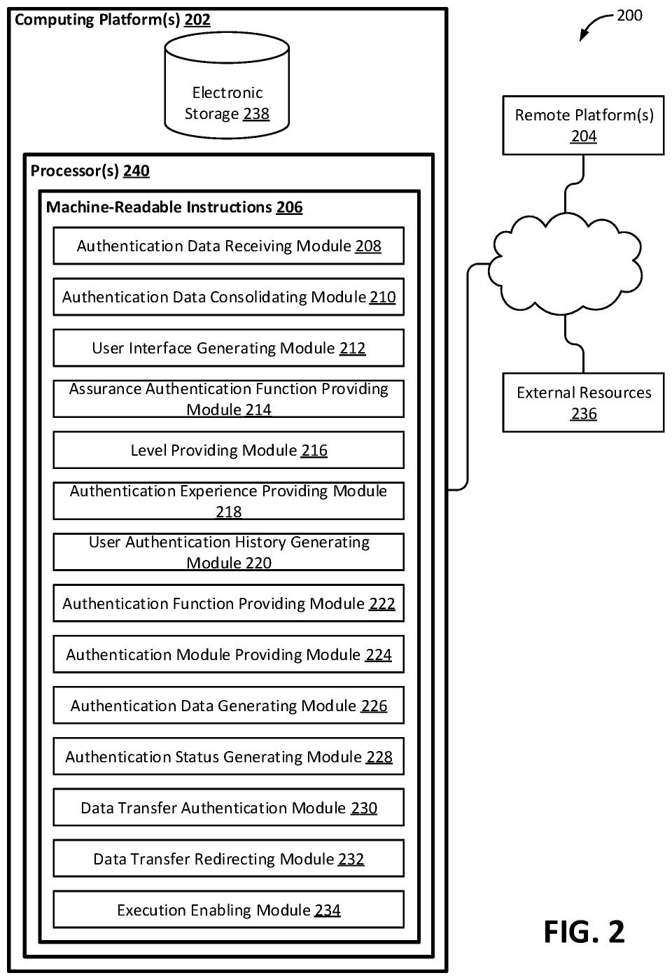

FIG. 2 illustrates a system 200 configured for providing multi-channel authentication, in accordance with one or more embodiments. In some embodiments, system 200 may include one or more computing platforms 202. Computing platform(s) 202 may be configured to communicate with one or more remote platforms 204 according to a client/server architecture, a peer-to-peer architecture, and/or other architectures. Remote platform(s) 204 may be configured to communicate with other remote platforms via computing platform(s) 202 and/or according to a client/server architecture, a peer-to-peer architecture, and/or other architectures. Users may access system 200 via remote platform(s) 204.

Computing platform(s) 202 may be configured by machine-readable instructions 206. Machine-readable instructions 206 may include one or more instruction modules. The instruction modules may include computer program modules. The instruction modules may include one or more of authentication data receiving module 208, authentication data consolidating module 210, user interface generating module 212, assurance authentication function providing module 214, level providing module 216, authentication experience providing module 218, user authentication history generating module 220, authentication function providing module 222, authentication module providing module 224, authentication data generating module 226, authentication status generating module 228, data transfer authentication module 230, data transfer redirecting module 232, execution enabling module 234, and/or other instruction modules.

Authentication data receiving module 208 may be configured to receive, from a plurality of system access channels, authentication data related to a plurality of data transfers and to a plurality of users. Each of the system access channels may provide access to functionality of the system in a different manner.

Authentication data receiving module 208 may be configured to receive, from a first system access channel, first authentication data.

Authentication data consolidating module 210 may be configured to consolidate the authentication data from the plurality of access channels to generate a set of consolidated authentication data.

User interface generating module 212 may be configured to generate a user interface, based on the set of consolidated authentication data, to enable execution of a centrally-provided authentication function at a selected system access channel for a selected user initiating a data transfer. User interface generating module 212 may be configured to generate the user interface based on the first authentication data, to enable execution of the centrally-provided authentication function via a second system access channel for the selected user initiating the data transfer.

Assurance authentication function providing module 214 may be configured to provide one or more high assurance authentication functions to the plurality of access channels. The high assurance functions may be not otherwise available to the plurality of access channels.

Level providing module 216 may be configured to provide a similar level of authentication and a similar risk profile for each of the plurality of system access channels. Level providing module 216 may be configured to provide, for a contact center access channel or an in-person access channel, a similar level of authentication and risk profile as an electronic self-serve access channel.

Authentication experience providing module 218 may be configured to provide a common authentication experience for each of the plurality of system access channels.

User authentication history generating module 220 may be configured to generate a user authentication history based on data in the set of consolidated authentication data associated with the selected user.

Authentication function providing module 222 may be configured to centrally provide the authentication function to the selected system access channel in the absence of availability of a similar native authentication function at the selected system access channel, or at one or more of the plurality of system access channels.

Authentication module providing module 224 may be configured to provide an authentication module at the plurality of system access channels. The provided authentication module may be configured for communication with the centrally-provided authentication function.

Authentication data generating module 226 may be configured to generate user-specific authentication data based on providing an authentication module at the plurality of system access channels. The authentication module may be configured for communication with the centrally-provided authentication function.

Authentication status generating module 228 may be configured to generate a current authentication status for the initiated data transfer. Generating the user interface may further include providing an indicator of available authentication functions based on the selected system access channel and the selected user and properties of the initiated data transfer. Authentication status generating module 228 may be configured to generate a current authentication status for the initiated data transfer.

Data transfer authentication module 230 may be configured to authenticate the initiated data transfer based on the current authentication status, satisfying one or more stored authentication criteria.

Data transfer redirecting module 232 may be configured to redirect the initiated data transfer to a different system access channel based on the current authentication status, failing to satisfy one or more stored authentication criteria associated with the selected system access channel.

Execution enabling module 234 may be configured to enable execution of a selected type of data transfer with reduced authentication requirements based on stored authentication data associated with successful authentication of prior instances of the selected type of data transfer for the selected user. The execution enabling module 234 may be used to enable simpler process flows for customers who repeatedly perform similar transactions or types of transactions. For example, execution enabling module 234 may be configured to interact with a back-end system to allow a customer to automatically pay a cable bill when the customer logs in, based on the customer's risk profile and authentication data obtained previously. This provides an improved process for a user, rather than having to go through all of the authentication steps each time, removing friction in the process. In an example implementation, execution enabling module 234 may be configured to authenticate a user to perform a particular type of data transfer with reduced authentication requirements, for example not even requiring the user to log in, if the user is using an app and a biometric authenticator, such as voiceprint technology, that enables the user to be recognized and authenticated using their voice.

In some implementations, by way of non-limiting example, the authentication function may be selected from the group consisting of a one-time passcode, multi-factor authentication, document verification, and a soft token authenticator.

In some embodiments, computing platform(s) 202, remote platform(s) 204, and/or external resources 236 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 202, remote platform(s) 204, and/or external resources 236 may be operatively linked via some other communication media.

A given remote platform 204 may include one or more processors configured to execute computer program modules. The computer program modules may be configured to enable an expert or user associated with the given remote platform 204 to interface with system 200 and/or external resources 236, and/or provide other functionality attributed herein to remote platform(s) 204. By way of non-limiting example, a given remote platform 204 and/or a given computing platform 202 may include one or more of a server, a desktop computer, a laptop computer, a handheld computer, a tablet computing platform, a NetBook, a Smartphone, a gaming console, and/or other computing platforms.

External resources 236 may include sources of information outside of system 200, external entities participating with system 200, and/or other resources. In some embodiments, some or all of the functionality attributed herein to external resources 236 may be provided by resources included in system 200.

Computing platform(s) 202 may include electronic storage 238, one or more processors 240, and/or other components. Computing platform(s) 202 may include communication lines, or ports to enable the exchange of information with a network and/or other computing platforms. Illustration of computing platform(s) 202 in FIG. 2 is not intended to be limiting. Computing platform(s) 202 may include a plurality of hardware, software, and/or firmware components operating together to provide the functionality attributed herein to computing platform(s) 202. For example, computing platform(s) 202 may be implemented by a cloud of computing platforms operating together as computing platform(s) 202.

Electronic storage 238 may comprise non-transitory storage media that electronically stores information. The electronic storage media of electronic storage 238 may include one or both of system storage that is provided integrally (i.e., substantially non-removable) with computing platform(s) 202 and/or removable storage that is removably connectable to computing platform(s) 202 via, for example, a port (e.g., a USB port, a firewire port, etc.) or a drive (e.g., a disk drive, etc.). Electronic storage 238 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 238 may include one or more virtual storage resources (e.g., cloud storage, a virtual private network, and/or other virtual storage resources). Electronic storage 238 may store software algorithms, information determined by processor(s) 240, information received from computing platform(s) 202, information received from remote platform(s) 204, and/or other information that enables computing platform(s) 202 to function as described herein.

Processor(s) 240 may be configured to provide information processing capabilities in computing platform(s) 202. As such, processor(s) 240 may include one or more of a digital processor, an analog processor, a digital circuit designed to process information, an analog circuit designed to process information, a state machine, and/or other mechanisms for electronically processing information. Although processor(s) 240 is shown in FIG. 2 as a single entity, this is for illustrative purposes only. In some embodiments, processor(s) 240 may include a plurality of processing units. These processing units may be physically located within the same device, or processor(s) 240 may represent processing functionality of a plurality of devices operating in coordination. Processor(s) 240 may be configured to execute modules 208, 210, 212, 214, 216, 218, 220, 222, 224, 226, 228, 230, 232, and/or 234, and/or other modules. Processor(s) 240 may be configured to execute modules 208, 210, 212, 214, 216, 218, 220, 222, 224, 226, 228, 230, 232, and/or 234, and/or other modules by software; hardware; firmware; some combination of software, hardware, and/or firmware; and/or other mechanisms for configuring processing capabilities on processor(s) 240. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 208, 210, 212, 214, 216, 218, 220, 222, 224, 226, 228, 230, 232, and/or 234 are illustrated in FIG. 2 as being implemented within a single processing unit, in embodiments in which processor(s) 240 includes multiple processing units, one or more of modules 208, 210, 212, 214, 216, 218, 220, 222, 224, 226, 228, 230, 232, and/or 234 may be implemented remotely from the other modules. The description of the functionality provided by the different modules 208, 210, 212, 214, 216, 218, 220, 222, 224, 226, 228, 230, 232, and/or 234 described below is for illustrative purposes, and is not intended to be limiting, as any of modules 208, 210, 212, 214, 216, 218, 220, 222, 224, 226, 228, 230, 232, and/or 234 may provide more or less functionality than is described. For example, one or more of modules 208, 210, 212, 214, 216, 218, 220, 222, 224, 226, 228, 230, 232, and/or 234 may be eliminated, and some or all of its functionality may be provided by other ones of modules 208, 210, 212, 214, 216, 218, 220, 222, 224, 226, 228, 230, 232, and/or 234. As another example, processor(s) 240 may be configured to execute one or more additional modules that may perform some or all of the functionality attributed below to one of modules 208, 210, 212, 214, 216, 218, 220, 222, 224, 226, 228, 230, 232, and/or 234.

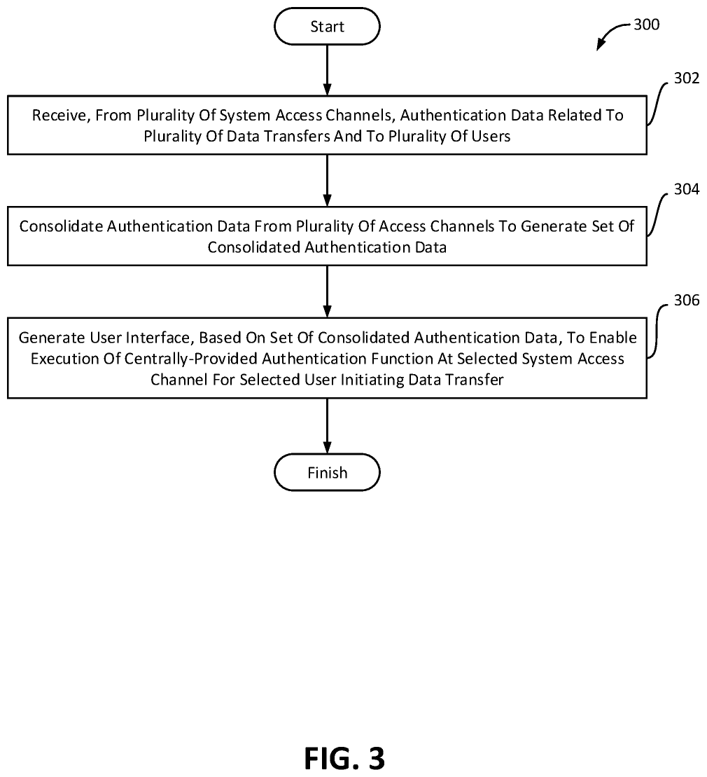

FIG. 3 illustrates a method 300 for providing multi-channel authentication, in accordance with one or more embodiments. The operations of method 300 presented below are intended to be illustrative. In some embodiments, method 300 may be accomplished with one or more additional operations not described, and/or without one or more of the operations discussed. Additionally, the order in which the operations of method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

An operation 302 may include receiving, from a plurality of system access channels, authentication data related to a plurality of data transfers and to a plurality of users. Each of the system access channels may provide access to functionality of the system in a different manner. Operation 302 may be performed by one or more hardware processors configured by machine-readable instructions including a module that is the same as or similar to authentication data receiving module 208, in accordance with one or more embodiments.

An operation 304 may include consolidating the authentication data from the plurality of access channels to generate a set of consolidated authentication data. Operation 304 may be performed by one or more hardware processors configured by machine-readable instructions including a module that is the same as or similar to authentication data consolidating module 210, in accordance with one or more embodiments.

An operation 306 may include generating a user interface, based on the set of consolidated authentication data, to enable execution of a centrally-provided authentication function at a selected system access channel for a selected user initiating a data transfer. Operation 306 may be performed by one or more hardware processors configured by machine-readable instructions including a module that is the same as or similar to user interface generating module 212, in accordance with one or more embodiments.

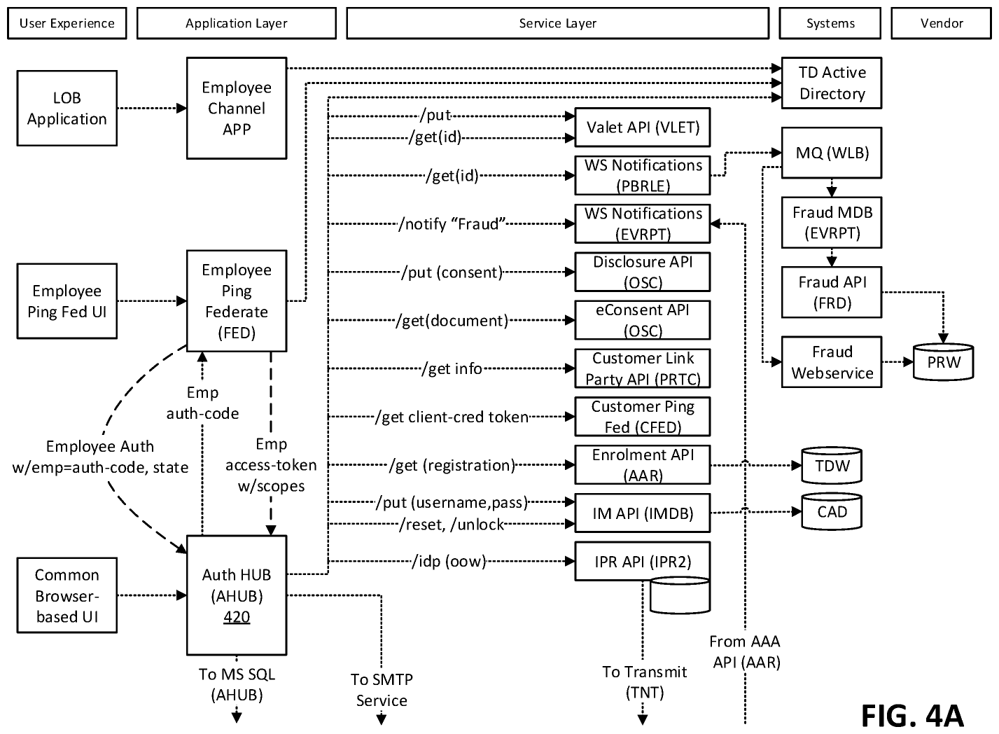

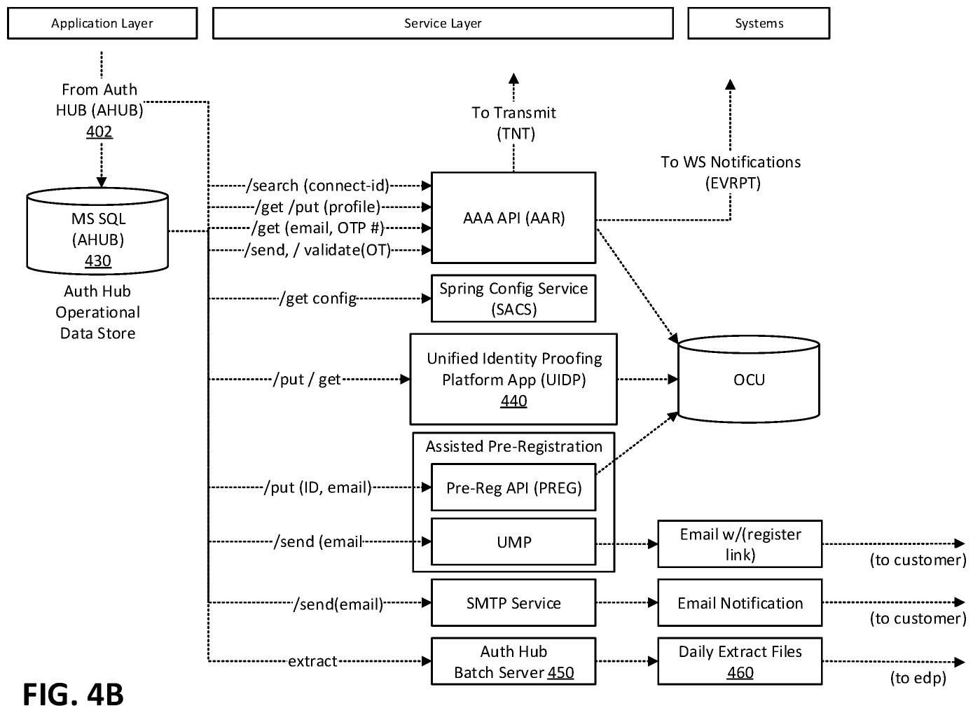

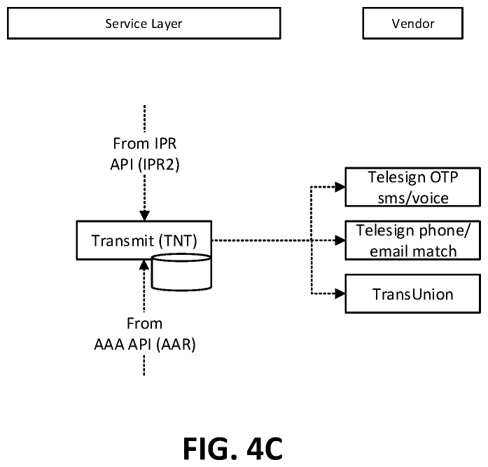

FIGS. 4A, 4B and 4C are block and flow diagrams illustrating a system and method for authentication according to an implementation, including an authentication hub (AuthHub) 420 as shown in FIG. 4A. The block and flow diagrams in FIGS. 4A-4C illustrate interactions between elements at a user experience layer, an application layer, a service layer, a systems layer, and a vendor layer.

The example embodiment as shown in FIGS. 4A-4C provides an employee-facing application 440 shown in FIG. 4B that may be configured to have insight into all of the authentication features, and may be configured to interact with all of these different access channels. The AuthHub 420 itself may be integrated into the applications that the system or system operator uses in each of the branches, the call center, and other business lines.

In an implementation, different systems communicate with the AuthHub 420 to indicate what a user is doing at that moment, and AuthHub will look up the user's digital information. Other systems will make AuthHub 420 aware of other information, for example when the user has used their automated teller machine (ATM) card, and at which location. Successful authentication using an authenticator is communicated to a central AuthHub 420.

The authentication hub 420 brings the information in, to help make business decisions in real-time. Information brought in by the authentication hub 420 may be stored in an authentication operational data store 430, such as an authentication database. The authentication hub 420 and the authentication database 430 obtain, store and provide information about what authentication has been done already, and determine whether this is sufficient authentication based on the requested data transfer. In an embodiment, the AuthHub 420 is segment-agnostic, meaning that it may interoperate with any number of different segments or lines of business, or system access channels. The AuthHub 420 may apply to all of the different segments equally, and may provide a facility to leverage the authentication capabilities that it has to offer. This may be enabled via a plurality of interactions with other pre-existing systems, or even new systems.

As shown in FIG. 4C, the system may comprise an authentication hub batch server 450 configured to extract authentication information from the authentication hub 420 and/or the authentication database 430, and to generate an authentication output, such as a daily extract of files 460.

The system of FIGS. 4A-4C is not just keeping track of authentication activity, but makes authentication functionality available to different segments that may not have that authentication functionality natively. For example, the authentication hub 420 may be configured to provide authentication functionality to one or more of the service layer elements shown in FIGS. 4A, 4B and 4C. The system is designed such that there is very little that cannot be done from an authentication perspective. The system may be applied to customer-facing implementations, as well as made available for internal employee representatives, to authenticate employees for certain activities.

As described herein, a system including an authentication hub as described and illustrated herein may cooperate with an authentication database to impart on a system access channel an authentication function that is absent from the system access channel, thereby improving functioning of a processor executing or associated with the system access channel. This reduces the processor load and cost, and reduces the memory required, compared to having to modify the system access channel to include the function. In some cases, there may be technical challenges preventing the modification of the system access channel to include the authentication function provided by the authentication hub of embodiments of the present disclosure.

The authentication hub may cooperate with an authentication database and/or an authentication user interface to improve functioning of a processor executing or associated with execution of the system access channel, by making the processor more efficient. For example, the authentication hub may impart an authentication function on the system access channel without the system access channel having the function, reducing the processor load and cost, as well as reducing the memory required. Such improvements and solutions to computer problems are also achieved by methods of one or more embodiments described and illustrated herein.

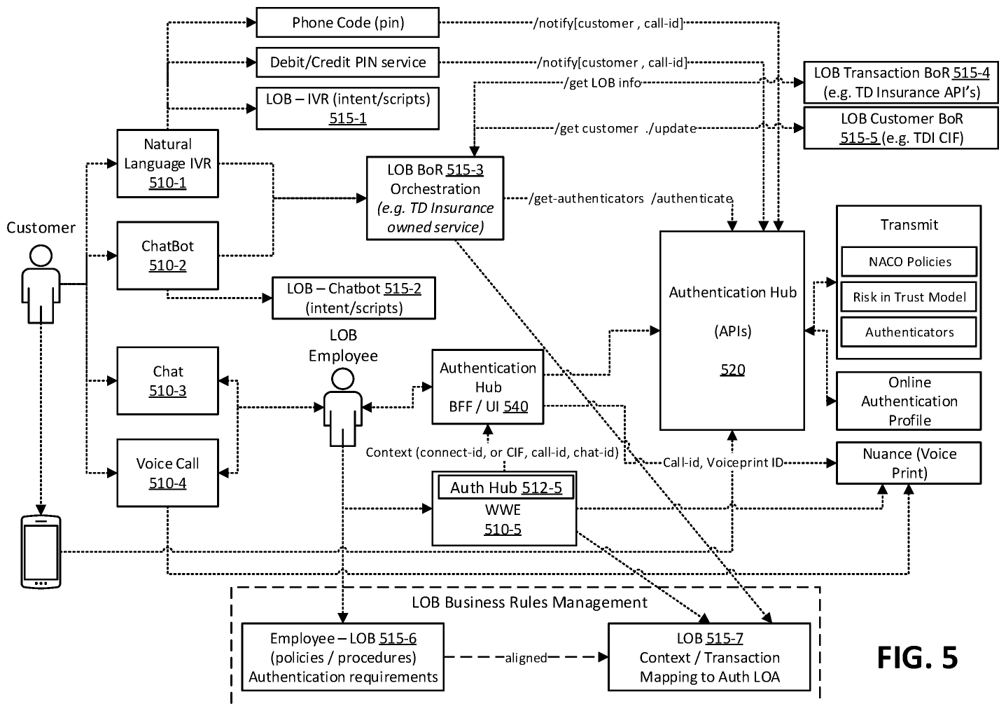

FIG. 5 is a block and flow diagram illustrating a system and method for authentication, including an authentication hub, according to another implementation. FIG. 5 illustrates a plurality of different access channels, such as Natural Language IVR (Interactive Voice Response) 510-1, ChatBot 510-2, Chat 510-3, Voice Call 510-4 and WWE 510-5. The plurality of access channels, which may represent parts of a call center ecosystem, are configured to interact with a number of lines of business (LOBs) 515-1, 515-2, 515-3, 515-4, 515-5, 515-6, 515-7, which are logically LOB-specific. The plurality of access channels are also configured to interact with an authentication hub 520, the implementation of which may include application program interfaces (APIs). FIG. 5 illustrates integration between how customers interact with IVR, and the system is configured to let an agent know that the customer needs to be authenticated to a certain level.

The authentication hub 520 may centralize authentication functionality and status information for an entire organization. An authentication database (not shown in FIG. 5) may be integrated with or in communication with the authentication hub 520 to consolidate authentication data from a plurality of access channels to generate a set of consolidated authentication data. In an implementation, the authentication hub 520 enables a plurality of LOBs to inherit authentication functionality as part of the authentication and platforms. As shown in FIG. 5, an authentication hub user interface UI) 520 may be generated based on the set of consolidated authentication data, to enable execution of a centrally-provided authentication function at a selected system access channel for a selected user initiating a data transfer

In an implementation, a customer may have called in through phone number, or look up caller ID. Workspace Web Edition (WWE) is an integrated desktop for call center, and is an example of the business line. An authentication module may be provided within an application, for example the authentication module 512-5 provided in the WWE module 510-5. Each solution can either have the AuthHub reside locally, or be in communication with a module, such as 512-5, that communicates with the AuthHub 520. AuthHub 520 already knows what authentication has already happened via another channel. AuthHub 520 can run on its own, or can be embedded in another application (like WWE), as shown with module 512-5.

When a system provides a plurality of ways that customers can authenticate, that information may be sent into the AuthHub 520 and be made available to an agent, for example via the UI 540. Authentication information associated with everything that is done by an employee using the AuthHub UI 540 may also be sent to the AuthHub API/database (not shown). The system may assign a risk factor to the current transaction based on the authentication data stored in the authentication hub from all of the different lines of business.

The system may ensure the same level of authentication and risk profile for all different lines of business. Based on known approaches, phone transactions may be more risky than online transactions, due to lack of MFA, etc.

The system may be configured to provide the information back to an agent, or a computing device associated with an agent, in real-time, so that the AuthHub indicates whether a transaction can proceed in a certain channel (e.g. online) or make the user use a different channel (go into branch). Compared to known backend processes that take 2 days to complete, the system of embodiments of the present disclosure is configured to provide data in real-time, or near-real-time, using a stronger authenticator and by having more information about the risk.

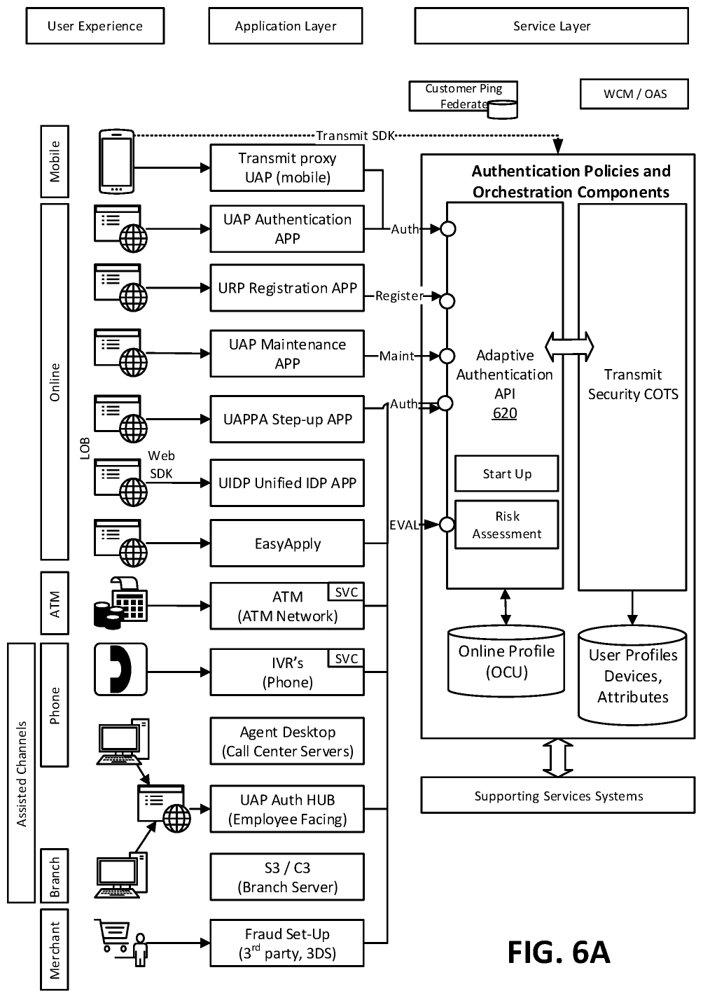

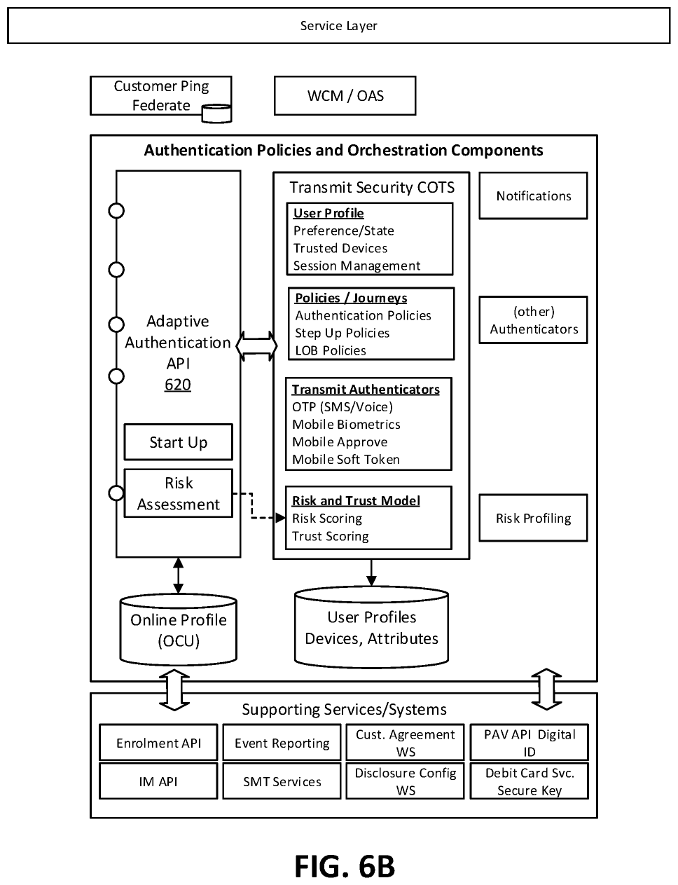

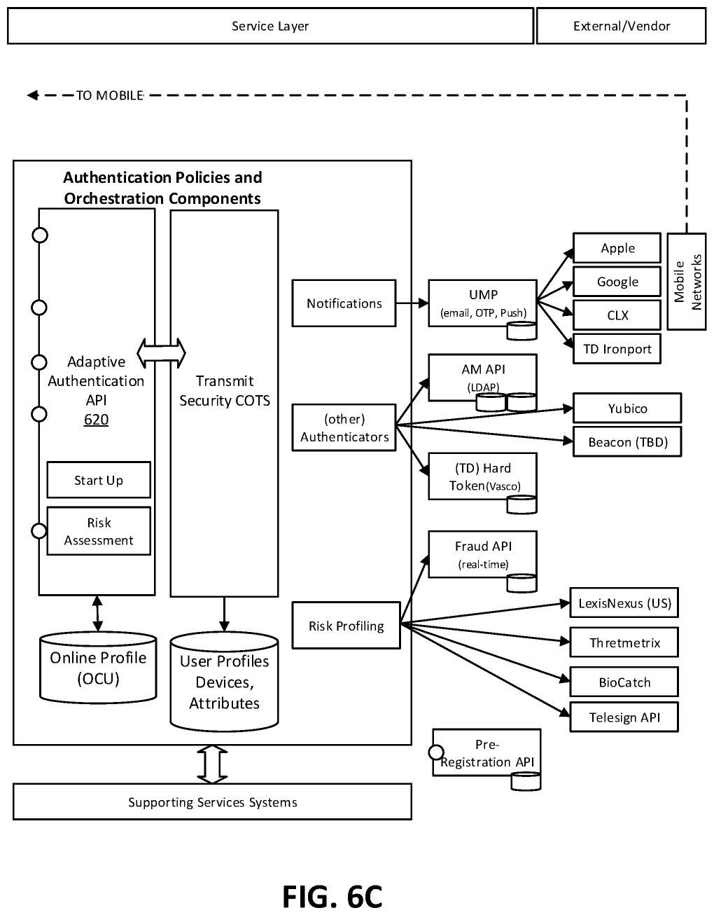

FIGS. 6A, 6B and 6C are block diagrams illustrating a system and method for authentication, including an authentication hub, according to a further implementation, and illustrating interaction with authentication policies and orchestration components. Some elements are intentionally repeated between FIGS. 6A-6C, to assist in illustrating interactions between the unique system components shown in each figure, in addition to the interactions between elements of the other figures. For example, authentication hub 620, shown as adaptive authentication API, is included in each of FIGS. 6A-6C to illustrate the interaction of the authentication hub with the components in each of those separate figures.

FIG. 6A illustrates a number of user experience elements and application layer elements that contribute to provide a plurality of system access channels. The AuthHub 620 of embodiments of the present disclosure is configured to provide intelligence that specifies the required level of authentication, and gives data from other LOBs and/or takes that data into account. The AuthHub 620 may have insight into all of the authentication events that have happened in different LOBs in the system, and may have different business rules configured for different business lines.

The authentication hub 620 of embodiments of the present disclosure provides foundational components to provide an employee has a tool that's common to different access paths or LOBs. In known approaches, an organization does not centrally manage how an employee is actually authenticating a customer. Even if a customer isn't digitally active, according to an embodiment of the present disclosure, and using the authentication hub 620, an agent can provide specific questions to ask a particular customer in a particular situation, for example using context-aware questions or authentication parameters.

The system may also be configured to be intelligent about which authenticators to use. For example, the system may be configured to prevent use of a one-time password (OTP) if a SIM card of the device being used was recently changed. The system may be configured to prevent any further progress in authentication, and force the process to use another method of communication. In this way, the system is configured to take away undesired employee flexibility in choosing which authentication approach is easiest vs. which is best, to provide greater security and reduce risk of fraud.

In an implementation, the system may integrate with a biometric authentication system, such as Nuance Voiceprint, and can determine whether a partial match is sufficient to authenticate, depending on the type of transaction. The system may also be configured to avoid risks of adding a different type of transaction to the call, without requiring enhanced authentication. For example, suppose a customer calls in to check a balance or pay a bill, which requires a first level of authentication. If the customer subsequently wants to do a large money transfer, the system is configured to ensure that the required second level of authentication is obtained, which may be overlooked by an agent who may be taken off-guard or can manually override based on subjective factors.

The authentication hub 620 is central, and is configured to make sure that if data does not agree or does not match what is expected, the system can redirect a user to use another access channel, such as going in to the branch. As shown in FIG. 6C, authentication hub 620 may be configured to provide one or more of authentication-related notifications, access to specific authenticators, and risk profiling, for example based on the consolidated authentication data for different users.

A contact center may process 10-20 million authentication events each day, and a system may need to have access to 30 days of authentication history. An authentication hub according to embodiments of the present disclosure may be configured to process and store all of this authentication information centrally, and to use the authentication information to permit or restrict customer transactions, independent of the access channel used. The system can be configured to determine instantly if there is any reason to be hesitant about proceeding further.

The authentication hub may be configured to enable providing authentication information to employees. A central authentication database may be used to store authentication data, including authentication transaction data, authentication profile data, etc. The authentication hub may allow an employee to perform/execute authentication, as well as have insight into other authentications that have occurred. With such functionality in place, the system may be used to bridge the gap between call center only and digital only, and provide the same authorization functionality and capability to those different lines of business.

Embodiments of the present disclosure provide consistent or improved authentication via an authentication hub to each of contact center, branches, and online services such as web-based or app-based services. With respect to business value, embodiments of the present disclosure including an authentication hub deliver an updated agent desktop link/interface that may be a “one stop shop” for contact center and branch, servicing customer authentication needs and challenges, such as password resets, registration in new authentication options, authenticating a customer, etc. Embodiments of the present disclosure build and extend the enterprise experience across assisted channels while leveraging existing investments made in digital platforms (UAP, URP, and Transmit).

With the introduction of the authentication hub, new high assurance methods may be utilized by contact center and in-person colleagues for authenticating customers, reducing/removing the reliance on security questions. This will allow the channels to service more customers and to keep them within the channel through the appropriate authentication levels and options.

When embodiments of the present disclosure providing an authentication hub are deployed, contact centre and branch channels will see a reduction in spend on change management for authentication solutions. Consistent authentication patterns will also be provided across self-serve and assisted channels, which will strengthen authentication controls and better manage fraud risk. Embodiments of the present disclosure, while solving a problem of providing authentication functions in a system access channel where such authentication functions are currently not available or supported, improve functioning of a processor executing or associated with the system access channel. This reduces the processor load and cost, and reduces the memory required, compared to having to modify the system access channel to include the function.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a compact disk read only memory (CD-ROM), digital versatile disk (DVD), Blu-ray Disc Read Only Memory (BD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

Embodiments of the disclosure can be described with reference to the following clauses, with specific features laid out in the dependent clauses:

One aspect of the present disclosure relates to a system configured for providing multi-channel authentication. The system may include one or more hardware processors configured by machine-readable instructions. The processor(s) may be configured to receive, from a plurality of system access channels, authentication data related to a plurality of data transfers and to a plurality of users. Each of the system access channels may provide access to functionality of the system in a different manner. The processor(s) may be configured to consolidate the authentication data from the plurality of access channels to generate a set of consolidated authentication data. The processor(s) may be configured to generate a user interface, based on the set of consolidated authentication data, to enable execution of a centrally-provided authentication function at a selected system access channel for a selected user initiating a data transfer.

In some implementations of the system, the processor(s) may be configured to provide one or more high assurance authentication functions to the plurality of access channels. In some implementations of the system, the high assurance functions may be not otherwise available to the plurality of access channels.

In some implementations of the system, the processor(s) may be configured to receive, from a first system access channel, first authentication data. In some implementations of the system, the processor(s) may be configured to generate the user interface based on the first authentication data to enable execution of the centrally-provided authentication function via a second system access channel for the selected user initiating the data transfer.

In some implementations of the system, the processor(s) may be configured to provide a similar level of authentication and a similar risk profile for each of the plurality of system access channels.

In some implementations of the system, the processor(s) may be configured to provide, for a contact center access channel or an in-person access channel, a similar level of authentication and risk profile as an electronic self-serve access channel.

In some implementations of the system, the processor(s) may be configured to provide a common authentication experience for each of the plurality of system access channels.

In some implementations of the system, the processor(s) may be configured to generate a user authentication history based on data in the set of consolidated authentication data associated with the selected user.

In some implementations of the system, the processor(s) may be configured to centrally provide the authentication function to the selected system access channel in the absence of availability of a similar native authentication function at the selected system access channel.

In some implementations of the system, the processor(s) may be configured to centrally provide the authentication function to the plurality of system access channels in the absence of availability of a similar native authentication function at one or more of the plurality of system access channels.

In some implementations of the system, the authentication function may be selected from the group consisting of a one-time passcode, multi-factor authentication, document verification, and a soft token authenticator.

In some implementations of the system, generating the user interface may further include providing an indicator of available authentication functions based on the selected system access channel and the selected user and properties of the initiated data transfer.

In some implementations of the system, the processor(s) may be configured to provide an authentication module at the plurality of system access channels. In some implementations of the system, the authentication module may be configured for communication with the centrally-provided authentication function.

In some implementations of the system, the processor(s) may be configured to generate user-specific authentication data based on providing an authentication module at the plurality of system access channels. In some implementations of the system, the authentication module may be configured for communication with the centrally-provided authentication function.

In some implementations of the system, the processor(s) may be configured to generate a current authentication status for the initiated data transfer. In some implementations of the system, the processor(s) may be configured to authenticate the initiated data transfer based on the current authentication status satisfying one or more stored authentication criteria.

In some implementations of the system, the processor(s) may be configured to generate a current authentication status for the initiated data transfer. In some implementations of the system, the processor(s) may be configured to redirect the initiated data transfer to a different system access channel based on the current authentication status failing to satisfy one or more stored authentication criteria associated with the selected system access channel.

In some implementations of the system, the processor(s) may be configured to enable execution of a selected type of data transfer with reduced authentication requirements based on stored authentication data associated with successful authentication of prior instances of the selected type of data transfer for the selected user.

Another aspect of the present disclosure relates to a method for providing multi-channel authentication. The method may include receiving, from a plurality of system access channels, authentication data related to a plurality of data transfers and to a plurality of users. Each of the system access channels may provide access to functionality of the system in a different manner. The method may include consolidating the authentication data from the plurality of access channels to generate a set of consolidated authentication data. The method may include generating a user interface, based on the set of consolidated authentication data, to enable execution of a centrally-provided authentication function at a selected system access channel for a selected user initiating a data transfer.

In some implementations of the method, it may include providing one or more high assurance authentication functions to the plurality of access channels. In some implementations of the method, the high assurance functions may be not otherwise available to the plurality of access channels.

In some implementations of the method, it may include receiving, from a first system access channel, first authentication data. In some implementations of the method, it may include generating the user interface based on the first authentication data to enable execution of the centrally-provided authentication function via a second system access channel for the selected user initiating the data transfer.

In some implementations of the method, it may include providing a similar level of authentication and a similar risk profile for each of the plurality of system access channels.

In some implementations of the method, it may include providing, for a contact center access channel or an in-person access channel, a similar level of authentication and risk profile as an electronic self-serve access channel.

In some implementations of the method, it may include providing a common authentication experience for each of the plurality of system access channels.

In some implementations of the method, it may include generating a user authentication history based on data in the set of consolidated authentication data associated with the selected user.

In some implementations of the method, it may include centrally providing the authentication function to the selected system access channel in the absence of availability of a similar native authentication function at the selected system access channel.

In some implementations of the method, it may include centrally providing the authentication function to the plurality of system access channels in the absence of availability of a similar native authentication function at one or more of the plurality of system access channels.

In some implementations of the method, the authentication function may be selected from the group consisting of a one-time passcode, multi-factor authentication, document verification, and a soft token authenticator.

In some implementations of the method, generating the user interface may further include providing an indicator of available authentication functions based on the selected system access channel and the selected user and properties of the initiated data transfer.

In some implementations of the method, it may include providing an authentication module at the plurality of system access channels. In some implementations of the method, the authentication module may be configured for communication with the centrally-provided authentication function.

In some implementations of the method, it may include generating user-specific authentication data based on providing an authentication module at the plurality of system access channels. In some implementations of the method, the authentication module may be configured for communication with the centrally-provided authentication function.

In some implementations of the method, it may include generating a current authentication status for the initiated data transfer. In some implementations of the method, it may include authenticating the initiated data transfer based on the current authentication status satisfying one or more stored authentication criteria.

In some implementations of the method, it may include generating a current authentication status for the initiated data transfer. In some implementations of the method, it may include redirecting the initiated data transfer to a different system access channel based on the current authentication status failing to satisfy one or more stored authentication criteria associated with the selected system access channel.

In some implementations of the method, it may include enabling execution of a selected type of data transfer with reduced authentication requirements based on stored authentication data associated with successful authentication of prior instances of the selected type of data transfer for the selected user.

Yet another aspect of the present disclosure relates to a non-transient computer-readable storage medium having instructions embodied thereon, the instructions being executable by one or more processors to perform a method for providing multi-channel authentication. The method may include receiving, from a plurality of system access channels, authentication data related to a plurality of data transfers and to a plurality of users. Each of the system access channels may provide access to functionality of the system in a different manner. The method may include consolidating the authentication data from the plurality of access channels to generate a set of consolidated authentication data. The method may include generating a user interface, based on the set of consolidated authentication data, to enable execution of a centrally-provided authentication function at a selected system access channel for a selected user initiating a data transfer.

In some implementations of the computer-readable storage medium, the method may include providing one or more high assurance authentication functions to the plurality of access channels. In some implementations of the computer-readable storage medium, the high assurance functions may be not otherwise available to the plurality of access channels.

In some implementations of the computer-readable storage medium, the method may include receiving, from a first system access channel, first authentication data. In some implementations of the computer-readable storage medium, the method may include generating the user interface based on the first authentication data to enable execution of the centrally-provided authentication function via a second system access channel for the selected user initiating the data transfer.

In some implementations of the computer-readable storage medium, the method may include providing a similar level of authentication and a similar risk profile for each of the plurality of system access channels.

In some implementations of the computer-readable storage medium, the method may include providing, for a contact center access channel or an in-person access channel, a similar level of authentication and risk profile as an electronic self-serve access channel.

In some implementations of the computer-readable storage medium, the method may include providing a common authentication experience for each of the plurality of system access channels.

In some implementations of the computer-readable storage medium, the method may include generating a user authentication history based on data in the set of consolidated authentication data associated with the selected user.

In some implementations of the computer-readable storage medium, the method may include centrally providing the authentication function to the selected system access channel in the absence of availability of a similar native authentication function at the selected system access channel.

In some implementations of the computer-readable storage medium, the method may include centrally providing the authentication function to the plurality of system access channels in the absence of availability of a similar native authentication function at one or more of the plurality of system access channels.

In some implementations of the computer-readable storage medium, the authentication function may be selected from the group consisting of a one-time passcode, multi-factor authentication, document verification, and a soft token authenticator.

In some implementations of the computer-readable storage medium, generating the user interface may further include providing an indicator of available authentication functions based on the selected system access channel and the selected user and properties of the initiated data transfer.

In some implementations of the computer-readable storage medium, the method may include providing an authentication module at the plurality of system access channels. In some implementations of the computer-readable storage medium, the authentication module may be configured for communication with the centrally-provided authentication function.

In some implementations of the computer-readable storage medium, the method may include generating user-specific authentication data based on providing an authentication module at the plurality of system access channels. In some implementations of the computer-readable storage medium, the authentication module may be configured for communication with the centrally-provided authentication function.

In some implementations of the computer-readable storage medium, the method may include generating a current authentication status for the initiated data transfer. In some implementations of the computer-readable storage medium, the method may include authenticating the initiated data transfer based on the current authentication status, satisfying one or more stored authentication criteria.

In some implementations of the computer-readable storage medium, the method may include generating a current authentication status for the initiated data transfer. In some implementations of the computer-readable storage medium, the method may include redirecting the initiated data transfer to a different system access channel based on the current authentication status failing to satisfy one or more stored authentication criteria associated with the selected system access channel.

In some implementations of the computer-readable storage medium, the method may include enabling execution of a selected type of data transfer with reduced authentication requirements based on stored authentication data associated with successful authentication of prior instances of the selected type of data transfer for the selected user.

Still another aspect of the present disclosure relates to a system configured for providing multi-channel authentication. The system may include means for receiving, from a plurality of system access channels, authentication data related to a plurality of data transfers and to a plurality of users. Each of the system access channels may provide access to functionality of the system in a different manner. The system may include means for consolidating the authentication data from the plurality of access channels to generate a set of consolidated authentication data. The system may include means for generating a user interface, based on the set of consolidated authentication data, to enable execution of a centrally-provided authentication function at a selected system access channel for a selected user initiating a data transfer.

In some implementations of the system, the system may include means for providing one or more high assurance authentication functions to the plurality of access channels. In some implementations of the system, the high assurance functions may be not otherwise available to the plurality of access channels.

In some implementations of the system, the system may include means for receiving, from a first system access channel, first authentication data. In some implementations of the system, the system may include means for generating the user interface based on the first authentication data to enable execution of the centrally-provided authentication function via a second system access channel for the selected user initiating the data transfer.

In some implementations of the system, the system may include means for providing a similar level of authentication and a similar risk profile for each of the plurality of system access channels.

In some implementations of the system, the system may include means for providing, for a contact center access channel or an in-person access channel, a similar level of authentication and risk profile as an electronic self-serve access channel.

In some implementations of the system, the system may include means for providing a common authentication experience for each of the plurality of system access channels.

In some implementations of the system, the system may include means for generating a user authentication history based on data in the set of consolidated authentication data associated with the selected user.

In some implementations of the system, the system may include means for centrally providing the authentication function to the selected system access channel in the absence of availability of a similar native authentication function at the selected system access channel.

In some implementations of the system, the system may include means for centrally providing the authentication function to the plurality of system access channels in the absence of availability of a similar native authentication function at one or more of the plurality of system access channels.

In some implementations of the system, the authentication function may be selected from the group consisting of a one-time passcode, multi-factor authentication, document verification, and a soft token authenticator.

In some implementations of the system, generating the user interface may further include providing an indicator of available authentication functions based on the selected system access channel and the selected user and properties of the initiated data transfer.

In some implementations of the system, the system may include means for providing an authentication module at the plurality of system access channels. In some implementations of the system, the authentication module may be configured for communication with the centrally-provided authentication function.

In some implementations of the system, the system may include means for generating user-specific authentication data based on providing an authentication module at the plurality of system access channels. In some implementations of the system, the authentication module may be configured for communication with the centrally-provided authentication function.

In some implementations of the system, the system may include means for generating a current authentication status for the initiated data transfer. In some implementations of the system, the system may include means for authenticating the initiated data transfer based on the current authentication status satisfying one or more stored authentication criteria.

In some implementations of the system, the system may include means for generating a current authentication status for the initiated data transfer. In some implementations of the system, the system may include means for redirecting the initiated data transfer to a different system access channel based on the current authentication status failing to satisfy one or more stored authentication criteria associated with the selected system access channel.

In some implementations of the system, the system may include means for enabling execution of a selected type of data transfer with reduced authentication requirements based on stored authentication data associated with successful authentication of prior instances of the selected type of data transfer for the selected user.

Even another aspect of the present disclosure relates to a computing platform configured for providing multi-channel authentication. The computing platform may include a non-transient computer-readable storage medium having executable instructions embodied thereon. The computing platform may include one or more hardware processors configured to execute the instructions. The processor(s) may execute the instructions to receive, from a plurality of system access channels, authentication data related to a plurality of data transfers and to a plurality of users. Each of the system access channels may provide access to functionality of the system in a different manner. The processor(s) may execute the instructions to consolidate the authentication data from the plurality of access channels to generate a set of consolidated authentication data. The processor(s) may execute the instructions to generate a user interface, based on the set of consolidated authentication data, to enable execution of a centrally-provided authentication function at a selected system access channel for a selected user initiating a data transfer.

In some implementations of the computing platform, the processor(s) may execute the instructions to provide one or more high assurance authentication functions to the plurality of access channels. In some implementations of the computing platform, the high assurance functions may be not otherwise available to the plurality of access channels.

In some implementations of the computing platform, the processor(s) may execute the instructions to receive, from a first system access channel, first authentication data. In some implementations of the computing platform, the processor(s) may execute the instructions to generate the user interface based on the first authentication data to enable execution of the centrally-provided authentication function via a second system access channel for the selected user initiating the data transfer.

In some implementations of the computing platform, the processor(s) may execute the instructions to provide a similar level of authentication and a similar risk profile for each of the plurality of system access channels.

In some implementations of the computing platform, the processor(s) may execute the instructions to provide, for a contact center access channel or an in-person access channel, a similar level of authentication and risk profile as an electronic self-serve access channel.

In some implementations of the computing platform, the processor(s) may execute the instructions to provide a common authentication experience for each of the plurality of system access channels.

In some implementations of the computing platform, the processor(s) may execute the instructions to generate a user authentication history based on data in the set of consolidated authentication data associated with the selected user.

In some implementations of the computing platform, the processor(s) may execute the instructions to centrally provide the authentication function to the selected system access channel in the absence of availability of a similar native authentication function at the selected system access channel.

In some implementations of the computing platform, the processor(s) may execute the instructions to centrally provide the authentication function to the plurality of system access channels in the absence of availability of a similar native authentication function at one or more of the plurality of system access channels.

In some implementations of the computing platform, the authentication function may be selected from the group consisting of a one-time passcode, multi-factor authentication, document verification, and a soft token authenticator.

In some implementations of the computing platform, generating the user interface may further include providing an indicator of available authentication functions based on the selected system access channel and the selected user and properties of the initiated data transfer.

In some implementations of the computing platform, the processor(s) may execute the instructions to provide an authentication module at the plurality of system access channels. In some implementations of the computing platform, the authentication module may be configured for communication with the centrally-provided authentication function.

In some implementations of the computing platform, the processor(s) may execute the instructions to generate user-specific authentication data based on providing an authentication module at the plurality of system access channels. In some implementations of the computing platform, the authentication module may be configured for communication with the centrally-provided authentication function.

In some implementations of the computing platform, the processor(s) may execute the instructions to generate a current authentication status for the initiated data transfer. In some implementations of the computing platform, the processor(s) may execute the instructions to authenticate the initiated data transfer based on the current authentication status satisfying one or more stored authentication criteria.

In some implementations of the computing platform, the processor(s) may execute the instructions to generate a current authentication status for the initiated data transfer. In some implementations of the computing platform, the processor(s) may execute the instructions to redirect the initiated data transfer to a different system access channel based on the current authentication status failing to satisfy one or more stored authentication criteria associated with the selected system access channel.

In some implementations of the computing platform, the processor(s) may execute the instructions to enable execution of a selected type of data transfer with reduced authentication requirements based on stored authentication data associated with successful authentication of prior instances of the selected type of data transfer for the selected user.

1. An apparatus configured for providing multi-channel authentication in a system, the apparatus comprising:
a non-transient computer-readable storage medium having executable instructions embodied thereon; and
one or more hardware processors configured to execute the instructions to:
receive, from a plurality of system access channels, authentication data related to a plurality of data transfers and to a plurality of users, 7 of the system access channels providing access to functionality of the system in a different manner;
consolidate the authentication data from the plurality of access channels to generate a set of consolidated authentication data; and
generate a user interface, based on the set of consolidated authentication data, to enable execution of a centrally-provided authentication function at a selected system access channel for a selected user initiating a data transfer.

2. The apparatus of claim 1, wherein the one or more hardware processors are further configured to execute the instructions to:
provide one or more high assurance authentication functions to the plurality of access channels, where the high assurance functions are not otherwise available to the plurality of access channels.

3. The apparatus of claim 1, wherein the one or more hardware processors are further configured to execute the instructions to:
receive, from a first system access channel, first authentication data; and
generate the user interface based on the first authentication data to enable execution of the centrally-provided authentication function via a second system access channel for the selected user initiating the data transfer.

4. The apparatus of claim 1, wherein the one or more hardware processors are further configured to execute the instructions to:
provide a similar level of authentication and a similar risk profile for each of the plurality of system access channels.

5. The apparatus of claim 1, wherein the one or more hardware processors are further configured to execute the instructions to:
generate a user authentication history based on data in the set of consolidated authentication data associated with the selected user.

6. The apparatus of claim 1, wherein the one or more hardware processors are further configured to execute the instructions to:
provide an authentication module at the plurality of system access channels, the authentication module configured for communication with the centrally-provided authentication function.

7. The apparatus of claim 1, wherein the one or more hardware processors are further configured to execute the instructions to:
generate a current authentication status for the initiated data transfer; and
authenticate the initiated data transfer based on the current authentication status satisfying one or more stored authentication criteria.

8. The apparatus of claim 1, wherein the one or more hardware processors are further configured to execute the instructions to:
generate a current authentication status for the initiated data transfer; and
redirect the initiated data transfer to a different system access channel based on the current authentication status failing to satisfy one or more stored authentication criteria associated with the selected system access channel.

9. The apparatus of claim 1, wherein the one or more hardware processors are further configured to execute the instructions to:
enable execution of a selected type of data transfer with reduced authentication requirements based on stored authentication data associated with successful authentication of prior instances of the selected type of data transfer for the selected user.

10. A computer-implemented method for providing multi-channel authentication, the method comprising:
receiving, from a plurality of system access channels, authentication data related to a plurality of data transfers and to a plurality of users, each of the system access channels providing access to functionality of the system in a different manner;
consolidating the authentication data from the plurality of access channels to generate a set of consolidated authentication data; and
generating a user interface, based on the set of consolidated authentication data, to enable execution of a centrally-provided authentication function at a selected system access channel for a selected user initiating a data transfer.

11. The method of claim 10, further comprising:
providing one or more high assurance authentication functions to the plurality of access channels, where the high assurance functions are not otherwise available to the plurality of access channels.

12. The method of claim 10, further comprising:
receiving, from a first system access channel, first authentication data; and
generating the user interface based on the first authentication data to enable execution of the centrally-provided authentication function via a second system access channel for the selected user initiating the data transfer.

13. The method of claim 10, further comprising:
providing a similar level of authentication and a similar risk profile for each of the plurality of system access channels.

14. The method of claim 10, further comprising:
generating a user authentication history based on data in the set of consolidated authentication data associated with the selected user.

15. The method of claim 10, further comprising:
providing an authentication module at the plurality of system access channels, the authentication module configured for communication with the centrally-provided authentication function.

16. The method of claim 10, further comprising:
generating a current authentication status for the initiated data transfer; and
authenticating the initiated data transfer based on the current authentication status satisfying one or more stored authentication criteria.

17. The method of claim 10, further comprising:
generating a current authentication status for the initiated data transfer; and
redirecting the initiated data transfer to a different system access channel based on the current authentication status failing to satisfy one or more stored authentication criteria associated with the selected system access channel.

18. The method of claim 10, further comprising:
enabling execution of a selected type of data transfer with reduced authentication requirements based on stored authentication data associated with successful authentication of prior instances of the selected type of data transfer for the selected user.

19. A non-transient computer-readable storage medium having instructions embodied thereon, the instructions being executable by one or more processors to perform a method for providing multi-channel authentication, the method comprising:
receiving, from a plurality of system access channels, authentication data related to a plurality of data transfers and to a plurality of users, each of the system access channels providing access to functionality of the system in a different manner;
consolidating the authentication data from the plurality of access channels to generate a set of consolidated authentication data; and
generating a user interface, based on the set of consolidated authentication data, to enable execution of a centrally-provided authentication function at a selected system access channel for a selected user initiating a data transfer.

20. The non-transient computer-readable storage medium of claim 19, wherein the method further comprises:
providing an authentication module at the plurality of system access channels, the authentication module configured for communication with the centrally-provided authentication function.
